(19) United States
(12) Patent Application Publication
(10) Pub. No.: US 2011/0110711 A1
(43) Pub. Date: May 12, 2011

(54) CHUCKLESS BUSHINGLESS JOINT DESIGN

(75) Inventors: James E. Basley, Rosemount (CA); William A. MacDonald, Aurora (CA); Reginald John P. Vibert, Toronto (CA); Rabindranath Persad, Brighton, MI (US); Nathan A. Jensen, Fowlerville, MI (US); Dmitriy Zelmanov, Oak Park, MI (US)

(73) Assignee: Intier Automotive Inc., Newmarket, ON (CA)

(21) Appl. No.: 12/735,960

(22) PCT Filed: Mar. 11, 2009
(86) PCT No.: PCT/CA2009/000304

§ 371 Date: Dec. 22, 2010

Related U.S. Application Data
(60) Provisional application No. 61/035,446, filed on Mar. 11, 2008.

(51) Int. Cl. F16C 11/04; B23P 11/00

(52) U.S. Cl. 403/161; 29/515

(57) ABSTRACT

A pivot joint includes a first member pivotally connected to a second member by a pivot pin. The first member includes a first surface, a second surface, and an opening extending therethrough. The opening is surrounded by a plurality of embossments protruding from the first surface and defining an embossment height. A second member includes a first surface, a second surface, and an opening extending therethrough. The pivot pin extends through the openings in the first and second members and includes a shoulder defining a shoulder height equal to the embossment height. The first surface of the second member engages the embossments and the shoulder to control axial free-play of the pivot joint. An inner surface of the opening in the first member engages the pivot pin to control diametrical free-play of the pivot joint.

### BACKGROUND OF THE INVENTION

1. Field of the Invention

The present invention relates to pivot joints, and more particularly, to a chuckless, bushingless pivot joint for pivotally connecting two links.

2. Description of Related Art

Pivotal connections between two members or links are common, particularly in seat assemblies for automotive vehicles which typically have a plurality of pivotal connections between pairs of links. Referring to FIG. 1, one of the most common types of pivotal connections 10 is formed with a conventional rivet or pivot pin 12 having a preformed head portion 14 and a malleable tubular body or shank 16 extending through a cylindrical opening 18, 20 in each link 22, 24 to be interconnected. A tail portion 26 of the shank 16 is compressed to form a second head, pivotally connecting the links 22, 24 between the first 14 and second 26 heads of the pivot pin 12.

One drawback of this type of pivotal connection is that with the straight pivot pin 12 pivotally connecting the two links 22, 24 it is almost impossible to manufacture a series of pivot joints without some having excessive looseness in an axial direction and others binding in the axial direction. Another drawback is that over time, as the pivot joint 10 wears, the openings 18, 20 which the pivot pin 12 extends through will tend to enlarge. The enlarged openings 18, 20 result in too much clearance diametrically between the pivot pin 12 and the links 22, 24, resulting in looseness in the pivot joint 10.

To address the drawbacks discussed above, it is well known to provide a pivot joint 100 between a first link 102 and a second link 104 with a bushing 106, as shown in FIG. 2. The bushing 106 is typically inserted in an opening 108 in the first link 102. The bushing 106 has a thickness greater than the thickness of the first link 102 such that when a pivot pin 110 is inserted through the bushing 106 and an opening 112 in the second link 104 to pivotally connect the first 102 and second 104 links, the second link 104 will abut against an end of the bushing 106 rather than against the first link 102. Therefore, compression of a tail portion 114 of a shank 116 of the pivot pin 110 to form a second head to retain the first 102 and second 104 links together does not cause the first 102 and second 104 links to bind together. Additionally, the bushing 106 controls the clearance diametrically between the pivot pin 110 and the first link 102.

It remains desirable, however, to provide a pivot joint for pivotally connecting a pair of links that does not require a bushing in order to control an axial tolerance between the pair of links. It is also desirable to provide an improved pivot joint that does not require a bushing for controlling a diametrical tolerance between a pivot pin and one of the links.

### SUMMARY OF THE INVENTION

According to one aspect of the invention, a chuckless bushingless pivot joint includes a first link and a second link. The first link is pivotally connected to the second link by a pivot pin. The first link includes an opening extending therethrough surrounded by four embossments protruding from a surface of the first link. The embossments define an embossment height. The second link includes an opening extending therethrough. The pivot pin includes a shank having a first portion and a second portion defining a shoulder therebetween. The shoulder defines a shoulder height. The first portion of the shank is disposed in the opening in the first link such that the shoulder height is equal to the embossment height. An inner surface of the opening in the first link is engaged with the first portion of the shank to control diametrical free-play of the first link relative to the pivot pin. The second link is engaged with the embossments and the shoulder to control axial free-play of the first link relative to the pivot pin.

According to another aspect of the invention, a method is provided for assembling a pivot joint including a first member having an opening surrounded by a plurality of embossments defining an embossment height, a second member having an opening, and a pivot pin having a shoulder defining a shoulder height. The method of assembling the pivot joint comprises the steps of: pressing the first member to form the plurality of embossments defining the embossment height; piercing the opening in the first member centrally between the plurality of embossments; inserting the pivot pin through the opening in the first member; deforming the first member adjacent the opening to urge material inwardly to eliminate diametrical free-play of the first member relative to the pivot pin; pressing the plurality of embossments down to the shoulder height of the pivot pin; inserting the pivot pin through the opening in the second member; and deforming the pivot pin to retain the second member against the plurality of embossments and the shoulder to eliminate axial free-play of the first member relative to the pivot pin.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1 is a fragmentary, cross-sectional side view of a first prior art pivot joint;

FIG. 2 is a fragmentary, cross-sectional side view of a second prior art pivot joint;

FIG. 3 is a fragmentary, cross-sectional side view of a pivot joint according to one embodiment of the invention;

FIG. 4A is a fragmentary, top perspective view of a first link illustrating a first assembly step of the pivot joint;

FIG. 4B is a fragmentary, bottom perspective view of the first link illustrating the first assembly step;

FIG. 4C is a fragmentary, top perspective view of the first link illustrating a second assembly step;

FIG. 4D is a fragmentary, cross-sectional side view taken along lines 4D-4D in FIG. 4C and a rivet;

FIG. 4E is a fragmentary, cross-sectional side view of a partially assembled pivot joint illustrating a third assembly step;

FIG. 4F is a fragmentary, top perspective view of the partially assembled pivot joint illustrating a fourth assembly step;

FIG. 4G is a fragmentary, cross-sectional side view taken along lines 4G-4G in FIG. 4F; and

FIG. 4H is a fragmentary, cross-sectional side view of the partially assembled pivot joint illustrating a fifth assembly step.

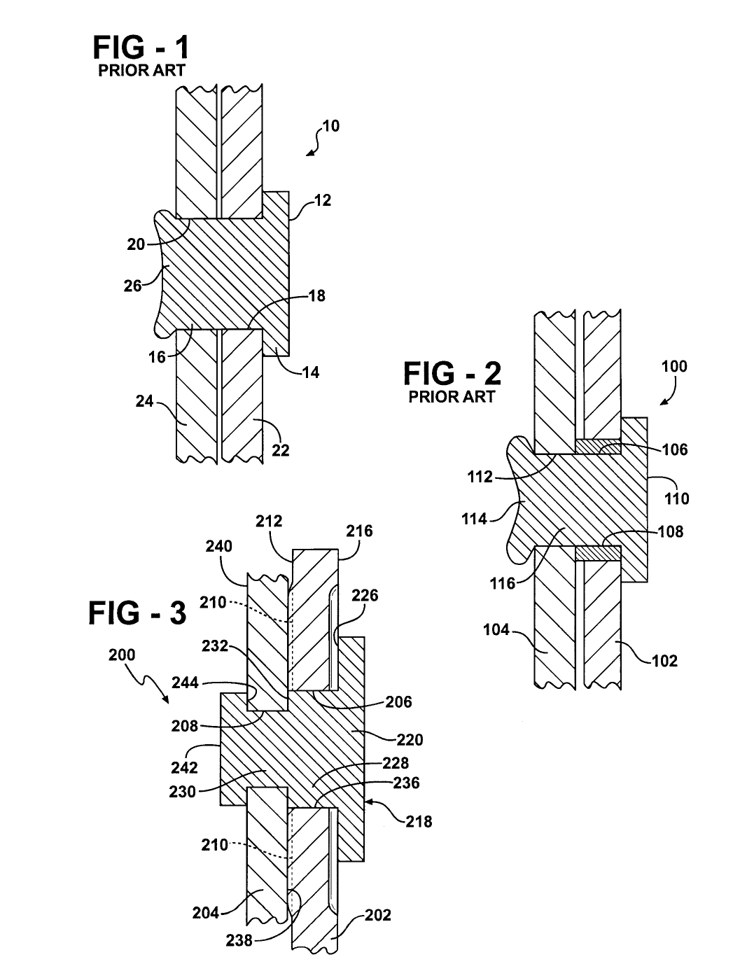

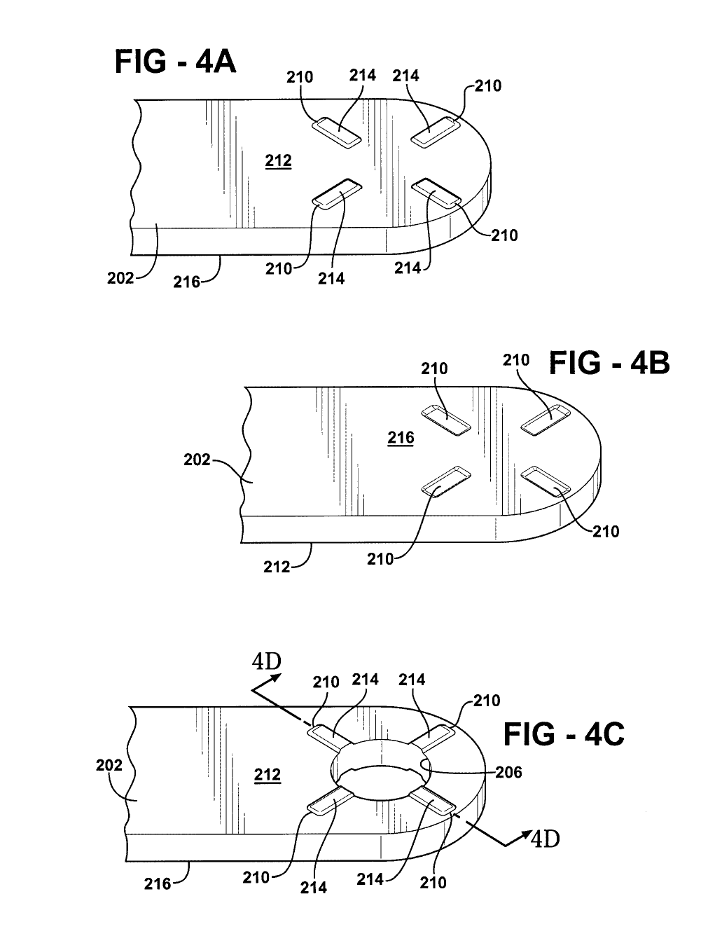

### DETAILED DESCRIPTION OF THE EMBODIMENTS

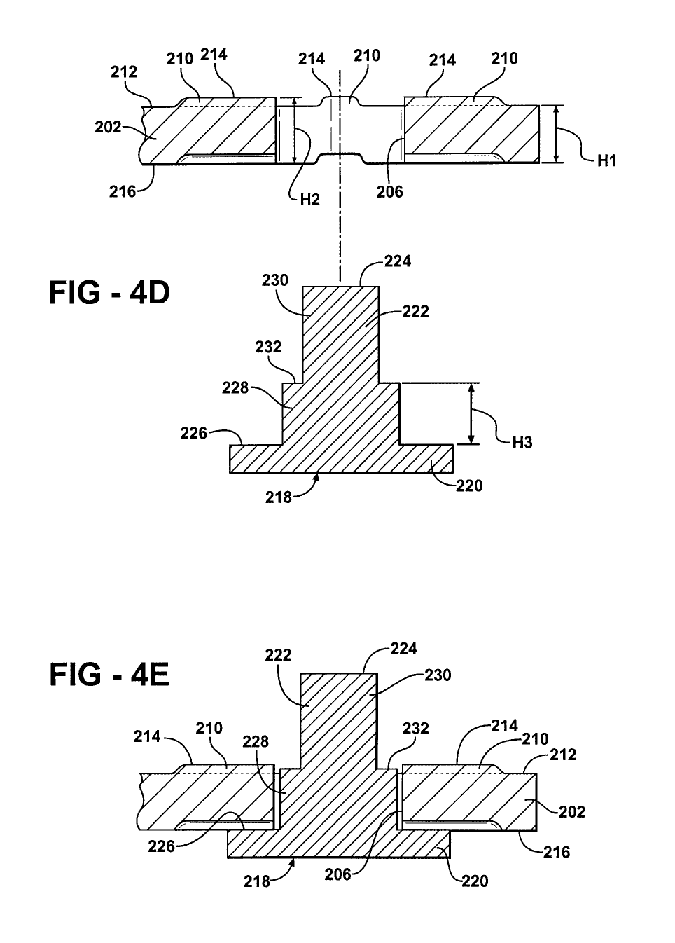

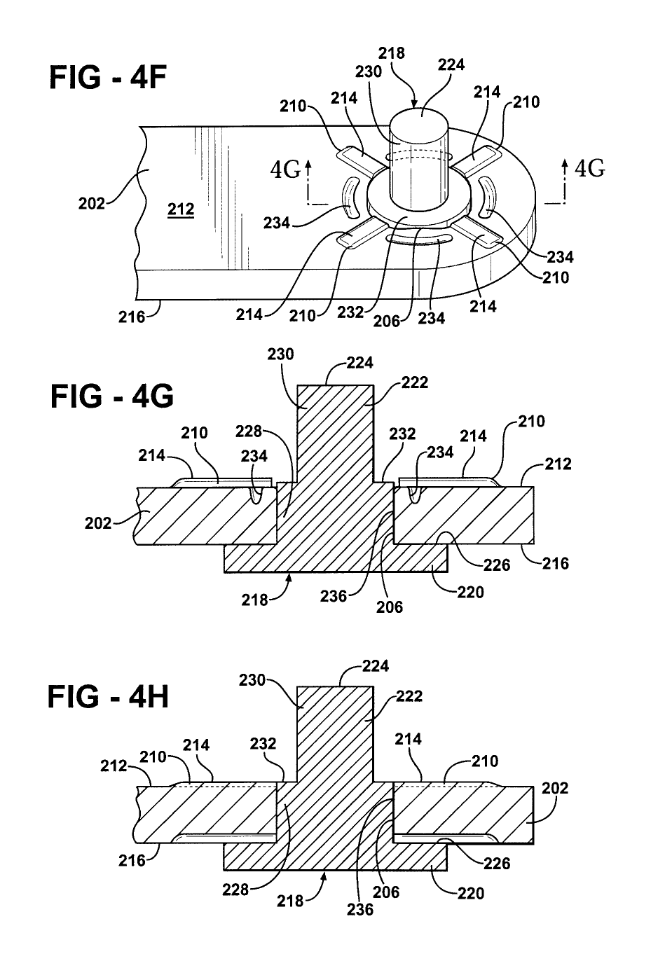

Referring to FIGS. 3 through 4H, a pivotal connection or pivot joint is generally shown at 200. The pivot joint 200 reduces wear and, at the same time, virtually eliminates undesirable axial and diametrical free-play. The pivot joint 200 of the present invention was particularly designed for use as a simple pivot joint for pivotally connecting members or links of a vehicle seat assembly. However, it will be appreciated that the pivot joint 200 may be used for pivotally connecting any of a variety of members without varying from the scope of the invention.

The pivot joint 200 includes a first or pivoting link 202 and a second or fixed link 204. Each of the first 202 and second 204 links include a cylindrical opening 206, 208 extending therethrough. The opening 206 in the first link 202 is larger than the opening 208 in the second link 204. A plurality of embossments 210 are disposed around the circumference of the opening 206 in the first link 202, as shown in FIGS. 4C and 4E. More specifically, in the embodiment shown, four embossments 210 are spaced equidistantly around the circumference of the opening 206. It is appreciated, however, that any number of embossments 210 could be disposed around the opening 206 without varying from the scope of the invention.

Prior to assembling the pivot joint 200, each embossment 210 extends upwardly from a first surface 212 of the first link 202 defining an upper surface 214. The first link 202 defines a height H1, best seen in FIG. 4D. The embossments 210 define a height H2 that is greater than the height H1 of the first link 202, also shown in FIG. 4D. To form the embossments 210 protruding from the first surface 212 of the first link 202, shown in FIG. 4A, a second surface 216 of the first link 202, shown in FIG. 4B, is pressed using an embossing tool. The opening 206 is then pierced through the first link 202 centrally between the embossments 210, as shown in FIG. 4C.

The first 202 and second 204 links are pivotally coupled together by a rivet or pivot pin 218 extending through the openings 206, 208 in the respective first 202 and second 204 links. More specifically, the rivet 218 is a shoulder rivet including a head portion 220, an elongated shank 222, and a tail portion 224. The head portion 220 includes a contact surface 226 and the shank 222 extends therefrom. The shank 222 includes a first portion 228 and a second portion 230 defining a rivet shoulder 232 therebetween.

During assembly of the pivot joint 200, the shank 222 of the rivet 218 is inserted through the opening 206 in the first link 202 such that the contact surface 226 of the head portion 220 engages the second surface 216 of the first link 202 and the first portion 228 of the shank 222 is disposed in the opening 206 therein. At this stage, the first portion 228 of the shank 222 is disposed loosely within the opening 206, shown in FIG. 4E. The height H1 of the first link 202 is less than a height H3 of the rivet shoulder 232 and the height H2 of the embossments 210 is greater than the height H3 of the rivet shoulder 232.

A coining ring tool is then used to form arcuate troughs 234 around the circumference of the opening 206 in the first surface 212 of the first link 202, shown in FIG. 4F. In the embodiment shown, one trough 234 is formed between each of the adjacent embossments 210 such that there are four troughs 234 in total. It is contemplated that any number of troughs 234 may be formed in the first link 202 without varying from the scope of the invention. Coining the first link 202 pushes link material from around the circumference of the opening 206 inwardly towards the first portion 228 of the shank 222, thereby eliminating diametrical free-play between the first link 202 and the shank 222 of the rivet 218. Thus, a bearing surface 236 is defined between an inner surface of the opening 206 and the first portion 228 of the shank 222, shown in FIG. 4G.

Next, the upper surface 214 of the embossments 210 are pressed down to the height H3 of the rivet shoulder 232, shown in FIG. 4H, using an emboss re-hit punch tool. Pressing the embossments 210 down to the height H3 of the rivet shoulder 232 provides a uniform surface consisting of the upper surface 214 of the embossments 210 and the rivet shoulder 232. When the first 202 and second 204 links are pivotally coupled together, the second link 204 abuts against the uniform surface, as described in detail below. It is contemplated that the amount of pressure required to press the embossments 210 will be enough to move the embossment material, but will not deform the rivet shoulder 232.

As shown in FIG. 3, the second portion 230 of the shank 222 is then inserted through the opening 208 in the second link 204 until a first surface 238 of the second link 204 abuts the uniform surface consisting of the upper surface 214 of the embossments 210 and the rivet shoulder 232, which are both at the same height H3. The pivot joint 200 is completed by staking or spin-riveting the tail portion 224 of the rivet 218, thereby deforming the tail portion 224 to retain the first 202 and second 204 links together. Deforming the tail portion 224 of the rivet 218 retains the second link 204 against the upper surface 214 of the embossments 210 and the rivet shoulder 232, thereby eliminating axial free-play of the first link 202 between the head portion 220 of the rivet 218 and the first surface 238 of the second link 204. Alternatively, it is contemplated that the tail portion 224 of the rivet 218 may be threaded for threadingly receiving a nut (not shown) to retain the first 202 and second 204 links together. Additionally, the rivet shoulder 232 and the embossments 210 prevent the first surface 238 of the second link 204 from contacting the first surface 212 of the first link 202 in order to limit the amount of friction therebetween when the first link 202 is pivoted relative to the second link 204.

The pivot joint 200 of the present invention is manufactured and assembled according to the following steps, which are illustrated in the accompanying FIGS. 4A through 4H. In a first step, the second surface 216 of the first link 202 is pressed using an embossing tool to form the embossments 210, which protrude from the first surface 212 thereof. At this stage, each embossment 210 extends upwardly from the first surface 212 of the first link 202 to the upper surface 214, defining the height H2.

In a second step, the opening 206 is pierced through the first link 202 centrally between the embossments 210.

In a third step, the shank 222 of the rivet 218 is inserted through the opening 206 in the first link 202 such that the contact surface 226 of the head portion 220 engages the second surface 216 of the first link 202. The first portion 228 of the shank 222 is disposed loosely within the opening 206. At this stage, the height H2 of the embossments 210 are greater than the height H3 of the rivet shoulder 232.

In a forth step, the first surface 212 of the first link 202 is coined to form the arcuate troughs 234 between adjacent embossments 210. Forming the troughs 234 pushes link material from around the circumference of the opening 206 inwardly towards the first portion 228 of the shank 222 to eliminate diametrical free-play between the first link 202 and the rivet 218.

In a fifth step, the upper surface 214 of the embossments 210 are pressed down to the height H3 of the rivet shoulder 232 to provide the uniform surface for engagement with the first surface 238 of the second link 204.

In a sixth step, the second portion 230 of the shank 222 is inserted through the opening 208 in the second link 204 until the first surface 238 of the second link 204 abuts the upper surface 214 of the embossments 210 and the rivet shoulder 232.

In a seventh step, the pivot joint 200 is completed by staking or spin-riveting the tail portion 224 of the rivet 218 to deform the tail portion 224 and retain the first 202 and second 204 links together. Retaining the second link 204 against the upper surface 214 of the embossments 210 and the rivet shoulder 232 eliminates axial free-play of the first link 202 between the head portion 220 of the rivet 218 and the first surface 238 of the second link 204.

The invention has been described here in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed:

1. A pivot joint comprising:
a first member including a first surface, an opposite second surface, and an opening extending through said first member between said first and second surfaces, said opening surrounded by a plurality of embossments protruding from said first surface and defining an embossment height;
a second member including a first surface, an opposite second surface, and an opening extending through said second member between said first and second surfaces; and
a pivot pin extending axially through said openings in said first and second members pivotally connecting said first and second members, said pivot pin having a shoulder defining a shoulder height equal to said embossment height, wherein said first surface of said second member engages said plurality of embossments and said shoulder thereby controlling axial free-play of said pivot joint and wherein an inner surface of said opening in said first member circumferentially engages said pivot pin thereby controlling diametrical free-play of said pivot joint.

2. A pivot joint as set forth in claim 1 further including at least two spaced apart embossments around said opening in said first member and protruding from said first surface to an upper surface, wherein said embossment height is defined between said upper surface of said embossment and said second surface of said first member.

3. A pivot joint as set forth in claim 2 wherein the distance between the first surface and opposite second surface of said first member defines a first height and wherein said embossment height is greater than said first height.

4. A pivot joint as set forth in claim 3 wherein said pivot pin includes a head portion and an elongated shank portion extending from said head portion to a distal tail portion.

5. A pivot joint as set forth in claim 4 wherein said shank portion of said pivot pin includes a first portion extending from said head portion and a second portion extending from said first portion to said tail portion, said first portion having a diameter larger than a diameter of said second portion and defining said shoulder therebetween.

6. A pivot joint as set forth in claim 5 wherein said head portion of said pivot shaft includes a first contact surface for engaging said first surface of said first link and a said tail portion includes a staked portion forming a second contact surface for engaging said second surface of said second link for retaining said first and second links therebetween.

7. A method of assembling a pivot joint including a first member having an opening surrounded by a plurality of embossments defining an embossment height, a second member having an opening, and a pivot pin having a shoulder defining a shoulder height, the method comprising the steps of:
pressing the first member to form the plurality of embossments defining the embossment height;
piercing the opening in the first member centrally between the plurality of embossments;
inserting the pivot pin through the opening in the first member;
deforming the first member adjacent the opening to urge material inwardly against said pivot pin to eliminate diametrical free-play of the first member relative to, the pivot pin;
pressing the plurality of embossments down to the shoulder height of the pivot pin;
inserting the pivot pin through the opening in the second member; and
deforming the pivot pin to retain the second member against the plurality of embossments and the shoulder to eliminate axial free-play of the first member relative to the pivot pin.
